(19) United States
(12) Patent Application Publication
(10) Pub. No.: US 2015/0333890 A1
(43) Pub. Date: Nov. 19, 2015

(54) PROCESSING DATA GRANTS AND HIGH SPEED DATA WITH A MEASUREMENT GAP

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/279,982

(22) Filed: May 16, 2014

(51) Int. Cl. H04L 5/00

(52) U.S. Cl. CPC H04L 5/0055

(57) ABSTRACT

In a method of wireless communication, a grant allocating a plurality of high speed subframes for high speed data channels is received before a measurement gap for tuning away from a serving radio access technology (RAT). At least one high speed subframe is allocated in the grant falling within the measurement gap. High speed data is processed only on high speed subframes of the plurality of high speed subframes before and after the measurement gap. An acknowledgement/negative acknowledgement (ACK/NACK) feedback is transmitting and only the high speed subframes of the plurality of high speed subframes before and after the measurement gap are considered.

### BACKGROUND

1. Field

Aspects of the present disclosure relate generally to wireless communication systems, and more particularly, to processing data grants and high speed data with a measurement gap in a wireless network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes receiving a grant allocating multiple high speed subframes for high speed data channels. The grant is received before a measurement gap for tuning away from a serving RAT. Moreover, one or more high speed subframes allocated in the grant fall within the measurement gap. The method also includes processing high speed data only on high speed subframes of the multiple high speed subframes before and after the measurement gap. The method further includes transmitting ACK/NACK feedback only considering the high speed subframes of the multiple high speed subframes before and after the measurement gap.

Another aspect of the present disclosure is directed to an apparatus including means for receiving a grant allocating multiple high speed subframes for high speed data channels. The grant is received before a measurement gap for tuning away from a serving RAT. Moreover, one or more high speed subframes allocated in the grant fall within the measurement gap. The apparatus also includes means for processing high speed data only on high speed subframes of the multiple high speed subframes before and after the measurement gap. The apparatus further includes means for transmitting ACK/NACK feedback only considering the high speed subframes of the multiple high speed subframes before and after the measurement gap.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of receiving a grant allocating multiple high speed subframes for high speed data channels. The grant is received before a measurement gap for tuning away from a serving RAT. Moreover, one or more high speed subframes allocated in the grant fall within the measurement gap. The program code also causes the processor(s) to process high speed data only on high speed subframes of the multiple high speed subframes before and after the measurement gap. The program code further causes the processor(s) to transmit ACK/NACK feedback only considering the high speed subframes of the multiple high speed subframes before and after the measurement gap.

Another aspect of the present disclosure is directed to an apparatus for wireless communication having a memory and at least one processor coupled to the memory. The processor(s) is configured to receive a grant allocating multiple high speed subframes for high speed data channels. The grant is received before a measurement gap for tuning away from a serving RAT. Moreover, one or more high speed subframes allocated in the grant fall within the measurement gap. The processor(s) is also configured to process high speed data only on high speed subframes of the multiple high speed subframes before and after the measurement gap. The processor(s) is further configured to transmit ACK/NACK feedback only considering the high speed subframes of the multiple high speed subframes before and after the measurement gap.

In one aspect of the present disclosure, a method of wireless communication is disclosed. The method includes transmitting a grant allocating a plurality of high speed subframes for high speed data channels. The grant is transmitted before a measurement gap for tuning away from a serving RAT. Moreover, one or more high speed subframes allocated in the grant fall within the measurement gap. The method also includes processing high speed data only on high speed subframes of the multiple high speed subframes before and after the measurement gap. The method further includes receiving ACK/NACK feedback only considering the high speed subframes of the multiple high speed subframes before and after the measurement gap.

Another aspect of the present disclosure is directed to an apparatus including means for receiving a grant allocating multiple high speed subframes for high speed data channels. The grant is received before a measurement gap for tuning away from a serving RAT. Moreover, one or more high speed subframe allocated in the grant fall within the measurement gap. The apparatus also includes means for processing high speed data only on high speed subframes of the multiple high speed subframes before and after the measurement gap. The apparatus further includes means for receiving ACK/NACK feedback only considering the high speed subframes of the multiple high speed subframes before and after the measurement gap.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of receiving a grant allocating multiple high speed subframes for high speed data channels. The grant is received before a measurement gap for tuning away from a serving RAT. Moreover, one or more high speed subframe allocated in the grant fall within the measurement gap. The program code also causes the processor(s) to process high speed data only on high speed subframes of the multiple high speed subframes before and after the measurement gap. The program code further causes the processor(s) to receive ACK/NACK feedback only considering the high speed subframes of the multiple high speed subframes before and after

Another aspect of the present disclosure is directed to an apparatus for wireless communication having a memory and at least one processor coupled to the memory. The processor(s) is configured to receive a grant allocating multiple high speed subframes for high speed data channels. The grant is received before a measurement gap for tuning away from a serving RAT. Moreover, one or more high speed subframe allocated in the grant fall within the measurement gap. The processor(s) is also configured to process high speed data only on high speed subframes of the multiple high speed subframes before and after the measurement gap. The processor(s) is further configured to receive ACK/NACK feedback only considering the high speed subframes of the multiple high speed subframes before and after the measurement gap.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5A, 5B, and 6 illustrate examples for processing high speed data according to an aspect of the present disclosure

FIGS. 7 and 8 are block diagrams illustrating a method for processing high speed data according to one aspect of the present disclosure.

FIGS. 9 and 10 are diagrams illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

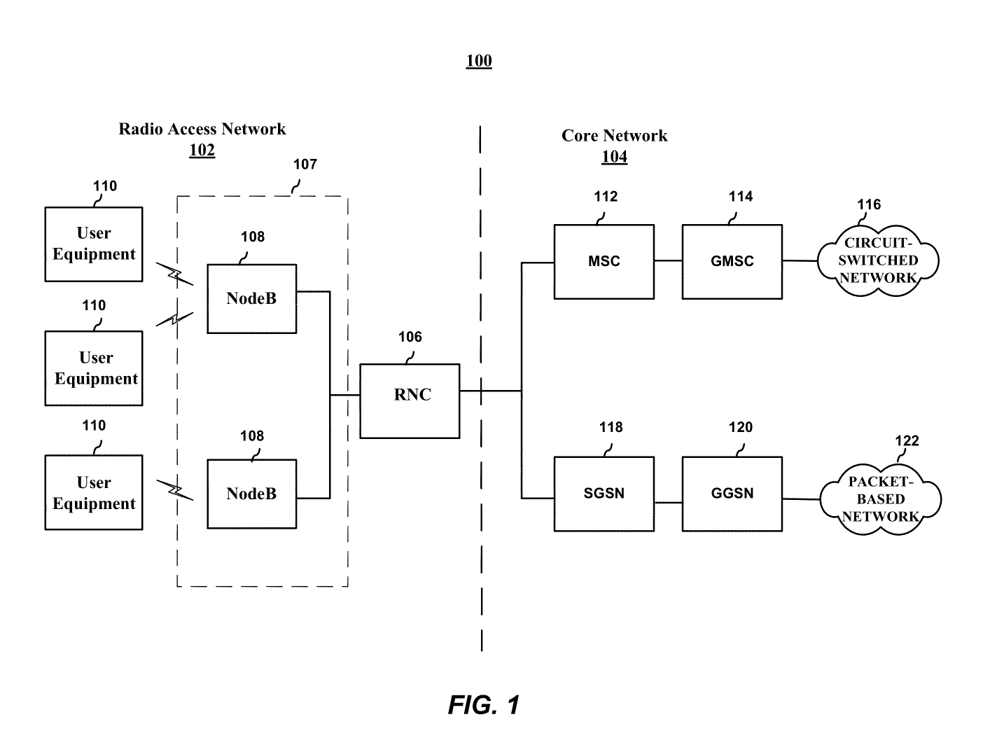

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

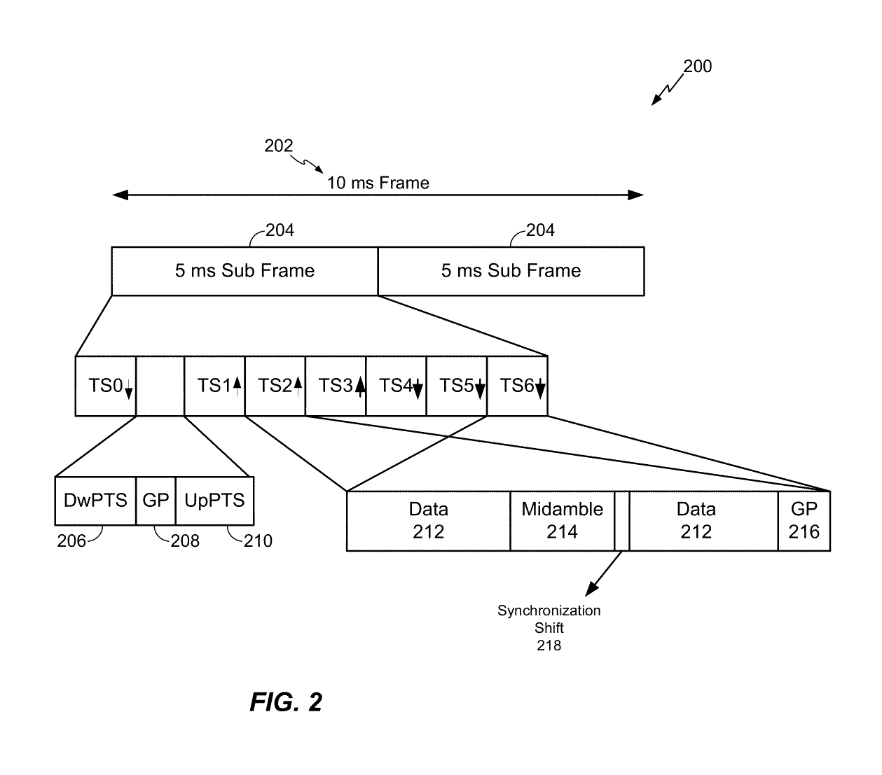

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

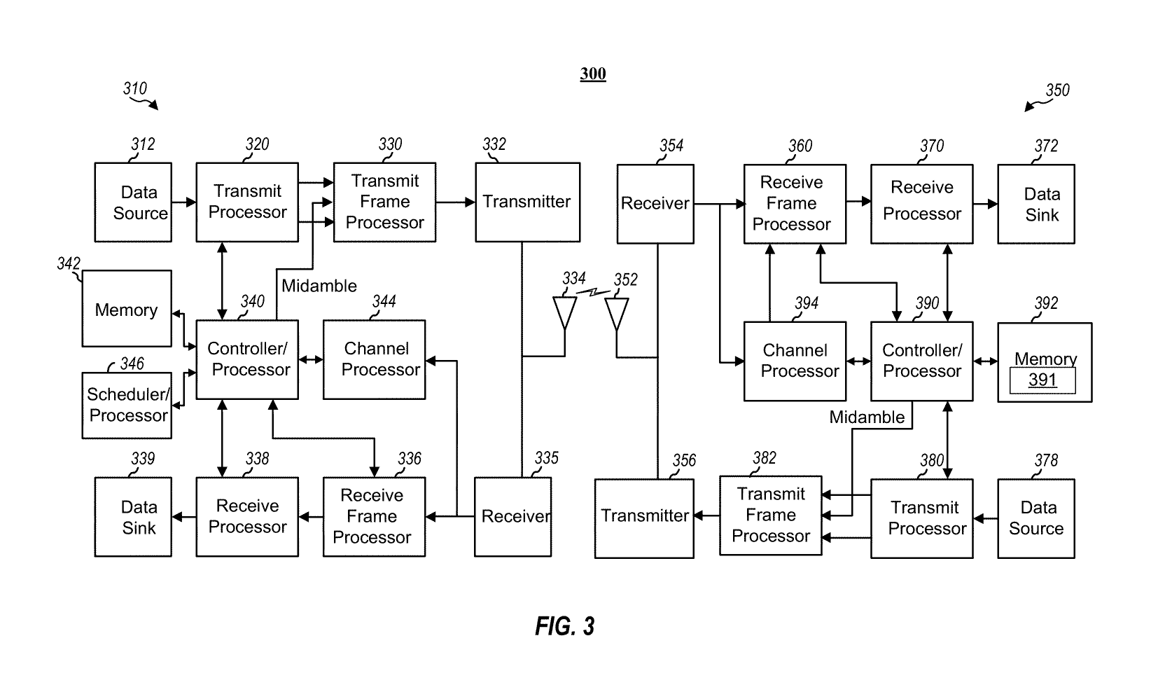

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a data processing module 391 which, when executed by the controller/processor 390, configures the UE 350 for processing high speed data only on high speed subframes before and after a measurement gap. A scheduler/processor 346 at the node B 310 may be used to allocate resources to the UEs and schedule downlink and/or uplink transmissions for the UEs. As another example, the memory 342 of the node B 310 may store a data processing module 341 which, when executed by the controller/processor 340, configures the node B 340 for processing high speed data only on high speed subframes before and after a measurement gap.

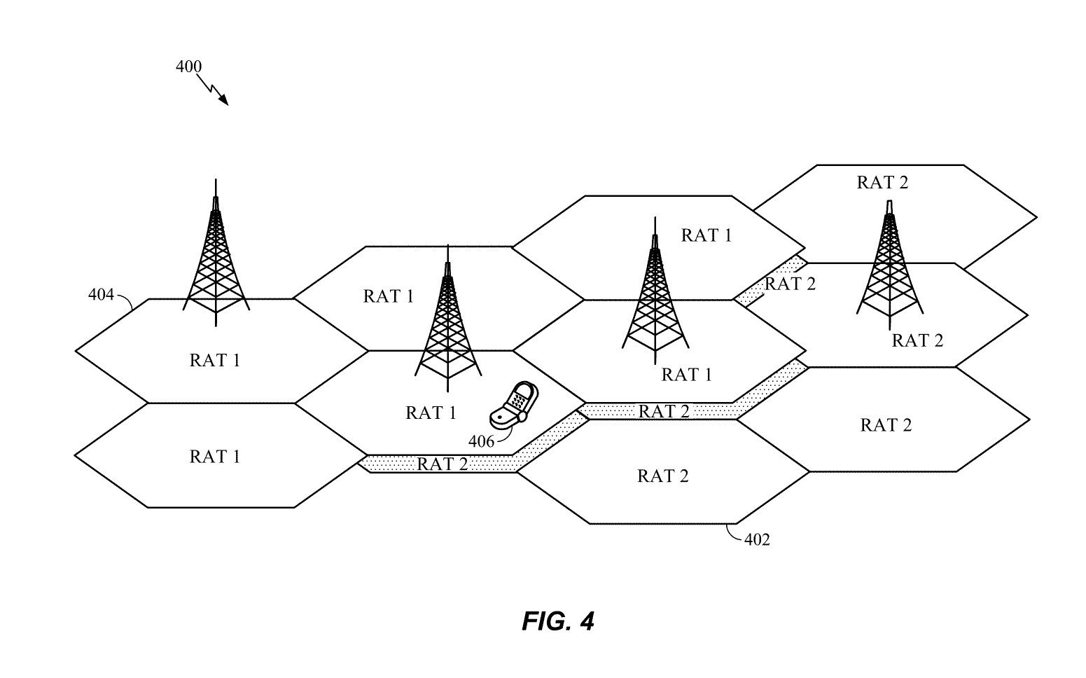

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of the broadcast control channel (BCCH) carrier, identifies the BSIC, at least one time, with an initial BSIC identification and reconfirms. The initial BSIC identification is performed within a predefined time period (for example, Tidentify_abort=5 seconds). The BSIC is re-confirmed at least once every Tre-confirm_abort seconds (e.g., Tre-confirm_abort=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

Processing Data Grants and High Speed Data with a Measurement Gap

In a high speed system, a grant channel may allocate one or more subframes for high speed data channels. The allocated subframes may be either consecutive or non-consecutive in the time domain. In one configuration, each subframe includes a high speed data channel. Furthermore, each subframe of multiple subframes may transmit the same data as other subframes. Additionally, each high speed data channel may transmit the same data as other high speed data channels. Alternatively, the subframes and/or the high speed data channels may transmit different data. In one configuration, one acknowledgement/negative acknowledgement (ACK/NACK) is transmitted when the same data is transmitted by the subframes and/or high speed data channels. In another configuration, one or more ACK/NACK(s) are transmitted when different data is transmitted by the subframes and/or high speed data channels.

Moreover, two different ACK/NAK feedback modes may be specified when different data is transmitted in the subframes and/or each high speed data channels. Specifically, one ACK/NAK feedback mode is a bundling mode and another ACK/NAK feedback mode is a multiplexing mode.

In one configuration, for the ACK/NAK feedback bundling mode, a single ACK/NAK is bundled by combining the ACK/NAKs from each downlink subframe assigned for high speed data channels. In one configuration, the ACK/NAKs are combined by ANDing the ACK/NAKs corresponding to each downlink subframe assigned for high speed data channels.

In another configuration, for the ACK/NAK feedback multiplexing mode, individual ACK/NAKs from each downlink (DL) subframe assigned for high speed data channel are multiplexed together. That is, the UE transmits multiple ACK/NAK bits in the feedback channel, each bit corresponds to high speed transport block carried in the downlink subframe. Moreover, the multiple ACK/NAK bits are multiplexed together.

In one configuration, measurement gaps are specified as time periods occurring during an idle interval for performing activity(S) for a non-serving RAT and/or non-serving frequency. The activity may include monitoring for paging information of a second RAT, collecting a system information block (SIB) of a second RAT, and/or performing cell reselection for a second RAT. In the present configuration, the idle interval may be based on an inter-RAT (IRAT) handover from a first RAT, such as TD-SCDMA, to a second RAT, such as LTE, or vice versa. For example, a handover may occur when a UE moves to an LTE coverage area during a packet switched call. In another example, a handover may occur when the UE initiates a circuit switched call or when the UE receives a page for a circuit switched call while associated with an LTE network that does not support voice calls.

In some cases, an IRAT handover may be based on event 3A measurement reporting. Event 3A triggering is based on TD-SCDMA and LTE filtered measurements. The LTE measurements may include an LTE serving reference signal receive power (RSRQ) and a reference signal receive quality (RSRQ). The TD-SCDMA measurements may include the TD-SCDMA primary common control physical channel (PCCPCH) receive signal code power (RSCP).

In one configuration, when a UE is in a connected mode, such as a TD-SCDMA connected mode, the network may inform the UE to use an idle interval or a dedicated channel measurement occasion (DMO) to perform IRAT measurements. Based on network standards, when the UE specifies an idle interval is needed for connected mode IRAT measurements, the network configures an idle interval for IRAT measurements in the connected mode. That is, the measurement gap is designated by the network so that the UE can tune away from the serving RAT and/or serving frequency to perform activity on the non-serving RAT (e.g., second RAT) and/or non-serving frequency. Typically, the idle interval is a 10 ms radio frame within a 40 or 80 ms period.

Additionally, the TD-SCDMA network may also configure a CELL_DCH (dedicated channel) measurement occasion for an IRAT measurement. In the CELL_DCH state, when a CELL_DCH measurement occasion pattern sequence is configured and activated for the specified measurement, the UE performs measurements as specified in the information element “Timeslot Bitmap” within the frames SFNstart to SFNstart+M_Length−1. The M_Length parameter is the actual measurement occasion length in frames starting from the offset and signalled by the information element “M_Length” in the information element “CELL_DCH measurement occasion info LCR.” The SFNstart frame allocation being based on the following equation:

SFNstart mod(2k)=offset. (1)

In Equation 1, k is a CELL_DCH measurement occasion cycle length coefficient and signalled by the information element “k” in the information element “CELL_DCH measurement occasion info LCR.” In one configuration, the actual measurement occasion period is equal to 2 k radio frames. Furthermore, the offset is the measurement occasion position in the measurement period and is signalled by the information element “Offset” in the information element “CELL_DCH measurement occasion info LCR”.

The M_Length is the actual measurement occasion length in frames beginning from the Offset and signalled by the information element “M_Length” in the information element “CELL_DCH measurement occasion info LCR.” During the idle interval/dedicated channel measurement occasion, the UE does not transmit or receive. The idle interval is 10 ms (e.g., M_Length) is configured to be less than a transmission time interval (TTI) of the dedicated channel measurement occasion.

The measurement gap of the present configuration may be based on the aforementioned measurement occasions, such as the CELL_DCH measurement occasion, the idle interval measurement occasion, and/or a dedicated channel measurement occasion. Aspects of the present disclosure are not limited to the aforementioned measurement occasions and the measurement gap may be based on any other type of measurement occasion.

In a conventional system, when a shared channel transmission, such as a high speed physical downlink shared channel (HS-PDSCH) transmission, is aligned with an idle interval or dedicated channel measurement occasion, the NodeB may not transmit a grant, such as a high speed shared control channel. Because the measurement gap is designated by the NodeB, the NodeB does not transmit the grant and the UE does not decode during idle interval or dedicated channel measurement occasion.

Moreover, in conventional systems, such as a conventional TD-HSDPA system, each shared control channel instance specifies the corresponding downlink shared channel allocation in the next sub frame. More specifically, the indicated downlink shared channel allocation is transmitted on the subframe that is subsequent to the shared control channel subframe.

For a high speed data call, multiple HARQ processes are scheduled for the UE on consecutive subframes. The UE receives a grant via a control channel, such as a high speed shared control channel, and data via a data channel, such as the high speed physical downlink shared channel, for each subframe in a set of consecutive subframes. Furthermore, the UE transmits the ACK/NACK via the feedback channel for different HARQ processes.

As previously discussed, when the NodeB configures an idle interval or dedicated channel measurement occasion, the first subframe prior to the measurement gap and the first subframe after the measurement gap are not used for receiving grants and data transmissions. That is, the subframe prior to the measurement gap is not used for transmitting a grant channel and the subframe after the measurement gap is not used for transmitting a high speed data channel. For example, for a 20 ms measurement with a 40 ms measurement gap, six subframes in one period cannot be used for high speed data scheduling and transmission. That is, the measurement gap may correspond to four subframes. Accordingly, the four subframes for the measurement gap and the subframes before and after the measurement gap cannot be used for high speed data scheduling and transmission.

Furthermore, in some cases, the NodeB transmits a grant on a subframe prior to the measurement gap even though the NodeB is aware the data transmission is aligned with the measurement gap. Specifically, in addition to indicating the subframe for the data transmission, the grant may include other information, such as power control adjustments and/or timing adjustments. Therefore, the NodeB may still transmit the grant in subframe prior to a measurement gap even when the data transmission falls within the measurement gap.

According to an aspect of the present disclosure, when a grant is transmitted in a subframe prior to the measurement gap, the high speed data is processed one or more subframes before and/or after the measurement gap. In one configuration, the subframe prior to the measurement gap refers to the first subframe before the measurement gap. Moreover, the measurement gap is specified for tuning away from a serving RAT and/or serving frequency. The high speed data is measured based on the grant information received before the measurement gap. Specifically, in the present configuration, when the grant is transmitted in a subframe prior to the measurement gap the NodeB transmits the data in one or more subframes before and/or after the measurement gap.

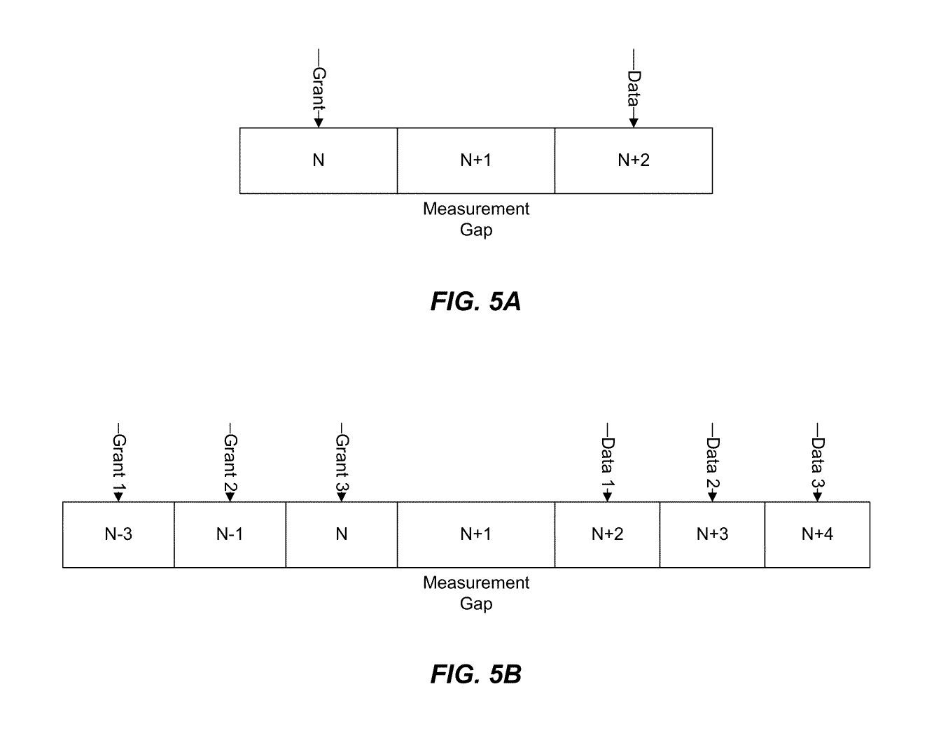

FIG. 5A illustrates an example for processing high speed data according to an aspect of the present disclosure. As shown in FIG. 5A, at subframe N the UE receives a grant from a NodeB. The grant may be received via a high speed channel, such as a high speed shared control channel. Furthermore, subframe N+1 is a measurement gap used to perform activity on a non-serving RAT and/or a non-serving frequency. In a conventional system, when data is transmitted during subframe N+1, the UE fails to decode the transmitted data. In one aspect of the present disclosure, the NodeB transmits the data in a subframe following the measurement gap. For example, as shown in FIG. 5A, the NodeB transmits the data in subframe N+2. The data may be high speed data transmitted via a high speed data channel, such as the high speed physical downlink shared channel. FIG. 5A illustrates data received in the first subframe, following the measurement gap.

FIG. 5B illustrates an example for processing high speed data according to an aspect of the present disclosure. As shown in FIG. 5B, a UE may receive consecutive grants (Grant 1-Grant 3) prior to measurement gap (subframe N+1). The grants may be received via a high speed channel, such as a high speed shared control channel. As previously discussed, in a conventional system, when data is transmitted during subframe N+1, the UE fails to decode one of the data subframes corresponding to the consecutive grants. In one aspect of the present disclosure, the NodeB transmits the data in a subframe following the measurement gap. For example, as shown in FIG. 5B, the NodeB transmits the first data associated with a first grant (Grant 1) in the first subframe after the measurement gap (subframe N+2). Moreover, the NodeB transmits the second data associated with a second grant (Grant 2) in the second subframe after the measurement gap (subframe N+3). Furthermore, the NodeB transmits the third data associated with a third grant (Grant 3) in the third subframe after the measurement gap (subframe N+4). The data may be high speed data transmitted via a high speed data channel, such as the high speed physical downlink shared channel.

FIGS. 5A and 5B illustrate data being received in the subframes immediately following the measurement gap. It should be noted that aspects of the present disclosure are not limited to receiving the data in the first subframe following the measurement gap, as the data may be received via one or more subframes prior to or following the measurement gap. Furthermore, both FIGS. 5A and 5B illustrate the measurement gap as one subframe. Still, aspects of the present disclosure are also contemplated for a measurement gap including more than one consecutive subframes.

It should further be noted that aspects of the present disclosure are not limited to receiving data in the subframe. Alternatively, the received grant may be a grant for an uplink transmission and the UE transmits uplink data via an uplink channel, such as a high speed physical uplink channel, in a subframe before or after the measurement gap.

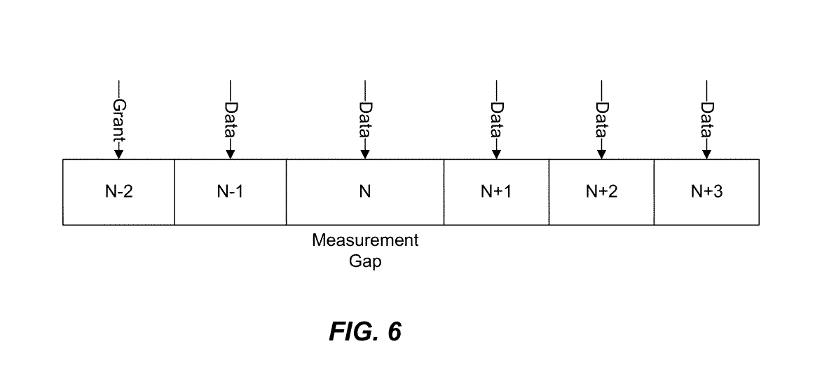

FIG. 6 illustrates an example for processing high speed data according to an aspect of the present disclosure. As shown in FIG. 6, at subframe N−2 the UE receives a grant from a NodeB. The grant may be received via a high speed channel, such as a high speed shared control channel. In one configuration, the grant allocates multiple subframes, such as high speed data subframes, for receiving and/or transmitting data, such as high speed data.

In a conventional system, when the grant allocates multiple subframes for receiving data and/or transmitting data, the bundled ACK/NAK feedback or multiplexed ACK/NAK are a NAK feedback if one or more of the subframes for receiving data or transmitting data fall within the measurement gap. For example, if a UE receives a grant allocating multiple subframes for receiving data and one of the subframes falls within a measurement gap, then the bundled ACK/NAK or multiplexed ACK/NAK is a NAK because the UE did not receive the data in a subframe that fell within the measurement gap. Thus, it may be desirable to improve the ACK/NAK feedback when a data subframe falls within the measurement gap.

As shown in FIG. 6, a grant allocates five subframes N−1, N, N+1, N+2, N+3 for receiving data. Moreover, in the present example, subframe N is designated as a measurement gap used to perform activity on a non-serving RAT and/or a non-serving frequency. In one configuration, the UE only processes the data that is received before and/or after the measurement gap. That is, the UE does not process the data that falls within the measurement gap. Therefore, in one configuration, the UE only transmits ACK/NAK feedback for data received before and/or after the measurement gap.

Based on aspects of the present disclosure, the high speed data is processed on one or more subframes before or after the measurement gap. In one configuration, the UE receives high speed data on a first subframe after the measurement gap and does not discard two subframes for every measurement period. Accordingly, receiving the grant in the first subframe before the measurement gap improves throughput of a system, such as a TD-HSDPA system.

Furthermore, in one configuration, the NodeB does not transmit a grant during a measurement gap. Specifically, because the NodeB designated the measurement gap, the NodeB is aware of the timing (e.g., subframe) of the measurement gap. Therefore, the NodeB does not transmit the grant during the measurement gap so that data corresponding to the grant transmitted prior to the measurement gap may be received by the UE. [Ming: is this correct?]

Additionally, in one configuration, when processing ACK/NAK feedback, the UE only determines the ACK/NAK feedback for the data received by the UE via subframes before and/or after the measurement gap. In another configuration, the UE processes ACK/NAK for data transmitted by the UE on subframes before and/or after the measurement gap. Furthermore, in one configuration, separate ACK/NAKs may be transmitted for each data transmission on a subframe before and after a measurement gap. That is, each ACK/NAK transmission corresponds to a single data transmission. Alternatively, as previously discussed, in another configuration, a bundled ACK/NAK feedback is transmitted for all of the data transmissions on subframes before and after measurement gap. In yet another configuration, as previously discussed, the multiplexed ACK/NAK feedback is transmitted for all of the data transmissions on subframes before and after measurement gap. Specifically, the ACK/NAK transmissions do not consider data transmissions that falls within the measurement gap.

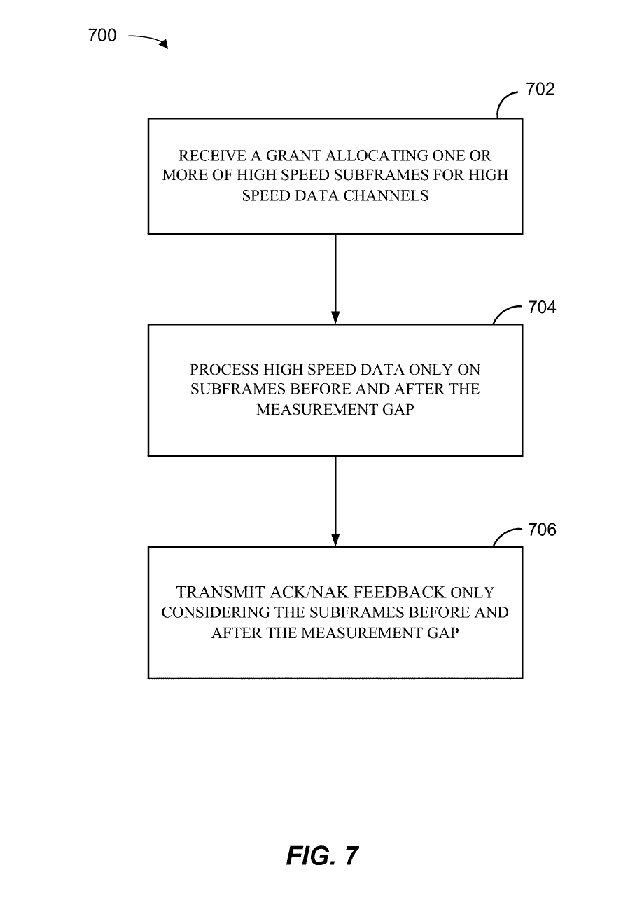

FIG. 7 shows a wireless communication method 700 according to one aspect of the disclosure. A UE receives a grant allocating one or more of high speed subframes for high speed data channels as shown in block 702. In one configuration, the grant is received before a measurement gap for tuning away from a serving RAT and/or serving frequency. Additionally, one of the high speed subframes allocated in the grant falls within the measurement gap. The UE also processes high speed data only on subframes before and after the measurement gap as shown in block 704. Furthermore, as shown in block 706, the UE transmits ACK/NAK feedback only considering the subframes before and after the measurement gap.

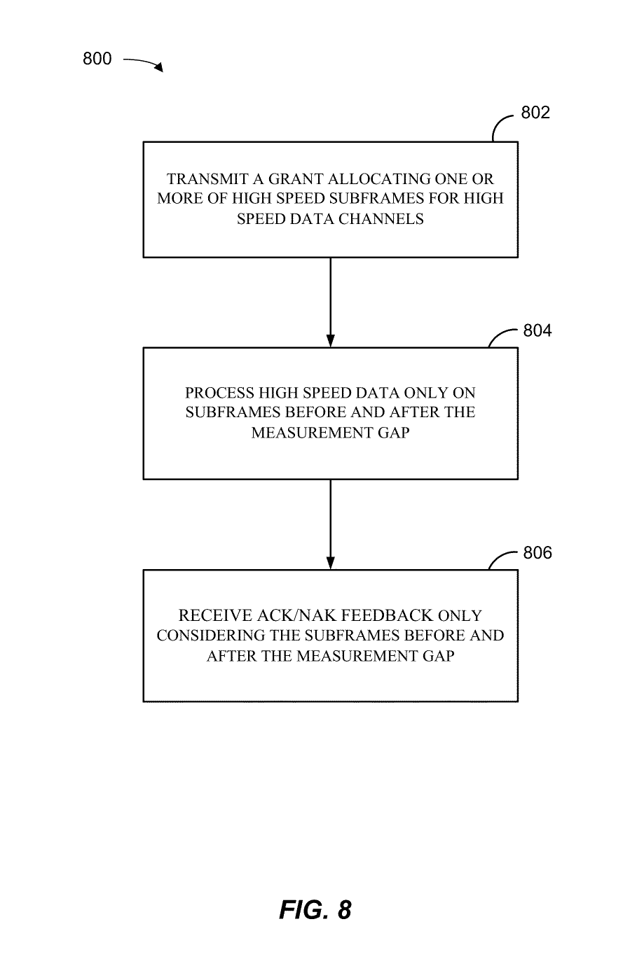

FIG. 8 shows a wireless communication method 800 according to one aspect of the disclosure. A NodeB transmits a grant allocating a purity of high speed subframes for high speed data channels as shown in block 802. In one configuration, the grant is transmitted before a measurement gap for tuning away from a serving RAT and/or serving frequency. Additionally, one of the high speed subframes allocated in the grant falls within the measurement gap. The NodeB also processes high speed data only on subframes before and after the measurement gap as shown in block 804. Furthermore, as shown in block 806, the NodeB receives ACK/NAK feedback only considering the subframes before and after the measurement gap.

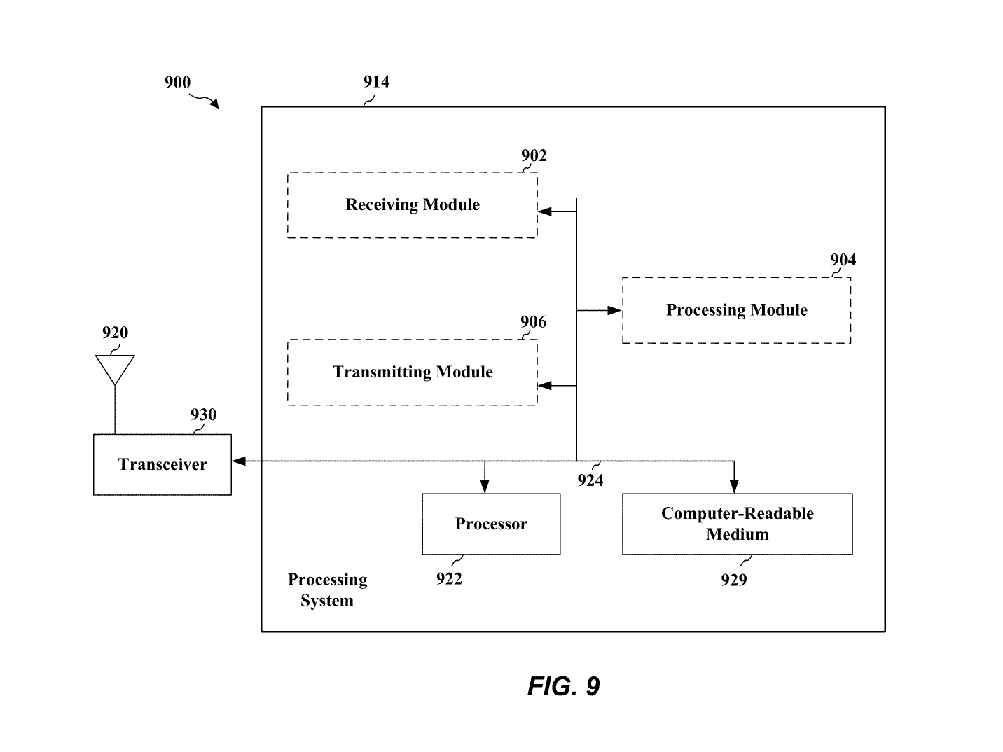

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922 the modules 902, 904, 906 and the non-transitory computer-readable medium 929. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 929. The processor 922 is responsible for general processing, including the execution of software stored on the computer-readable medium 929. The software, when executed by the processor 922, causes the processing system 914 to perform the various functions described for any particular apparatus. The computer-readable medium 929 may also be used for storing data that is manipulated by the processor 922 when executing software.

The processing system 914 includes a receiving module 902 for receiving a grant allocating one or more of high speed subframes for high speed data channels. The processing system 914 includes a processing module 904 for processing high speed data only on subframes before and after the measurement gap. The processing system 914 also includes a transmitting module 906 for transmitting ACK/NAK feedback only considering the subframes before and after the measurement gap. The modules may be software modules running in the processor 922, resident/stored in the computer readable medium 929, one or more hardware modules coupled to the processor 922, or some combination thereof. The processing system 914 may be a component of the UE 350 and may include the memory 392, and/or the controller/processor 390.

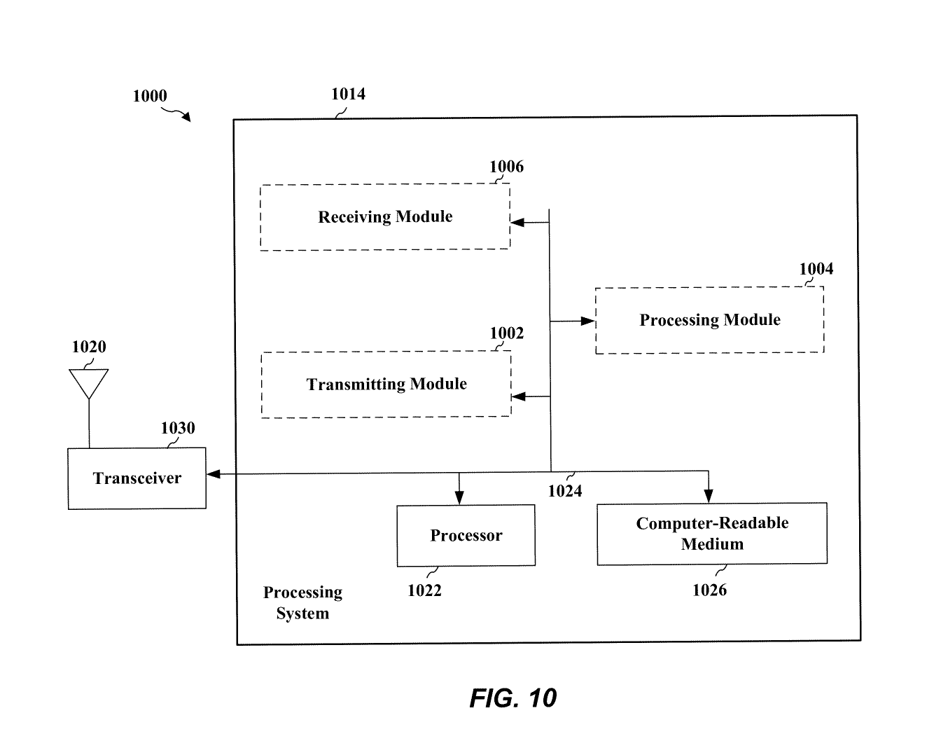

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022 the modules 1002, 1004, 1006 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a transmitting module 1002 for transmitting a grant allocating one or more of high speed subframes for high speed data channels. The processing system 1014 includes a processing module 1004 for processing high speed data only on subframes before and after the measurement gap. The processing system 1014 also includes a receiving module 1006 for receiving ACK/NAK feedback only considering the subframes before and after the measurement gap. The modules may be software modules running in the processor 1022, resident/stored in the computer readable medium 1026, one or more hardware modules coupled to the processor 1022, or some combination thereof. The processing system 1014 may be a component of the or node B 310 and may include the memory 342, and/or the controller/processor 340.

In one configuration, an apparatus such as a UE is configured for wireless communication including means for receiving. In one aspect, the receiving means may be the antennas 352, the receiver 354, the channel processor 394, the receive frame processor 360, the receive processor 370, the controller/processor 390, the memory 392, data processing module 391, receiving module 902, and/or the processing system 914 configured to perform the receiving. The UE is also configured to include means for processing. In one aspect, the processing means may be the antennas 352, the receiver 354, the channel processor 394, the receive frame processor 360, the receive processor 370, the transmitter 356, the transmit frame processor 382, the transmit processor 380, the controller/processor 390, the memory 392, data processing module 391, processing module 904, and/or the processing system 914 configured to perform the processing. The UE is also configured to include means for transmitting. In one aspect, the transmitting means may be the antennas 352, the transmitter 356, the transmit frame processor 382, the transmit processor 380, the controller/processor 390, the memory 392, data processing module 391, transmitting module 906, and/or the processing system 914 configured to perform the processing. In one configuration, the means functions correspond to the aforementioned structures. In another aspect, the aforementioned means may be a module or any apparatus configured to perform the functions recited by the aforementioned means.

In one configuration, an apparatus such as a NodeB is configured for wireless communication including means for receiving. In one aspect, the receiving means may be the antennas 334, the receiver 335, the channel processor 344, the receive frame processor 336, the receive processor 338, the controller/processor 340, the memory 342, data processing module 341, receiving module 1006, and/or the processing system 1014 configured to perform the receiving. The NodeB is also configured to include means for processing. In one aspect, the processing means may be the antennas 334, the receiver 335, the channel processor 344, the receive frame processor 336, the receive processor 338 the transmitter 332, the transmit frame processor 330, the transmit processor 320, the controller/processor 340, the memory 342, data processing module 341, processing module 1004, and/or the processing system 1014 configured to perform the processing. The NodeB is also configured to include means for transmitting. In one aspect, the transmitting means may be the antennas 334, the transmitter 332, the transmit frame processor 330, the transmit processor 320, the controller/processor 340, the memory 342, data processing module 341, transmitting module 1002, and/or the processing system 1014 configured to perform the processing. In one configuration, the means functions correspond to the aforementioned structures. In another aspect, the aforementioned means may be a module or any apparatus configured to perform the functions recited by the aforementioned means.

Several aspects of a telecommunications system has been presented with reference to TD-SCDMA and High speed uplink packet access systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a grant allocating a plurality of high speed subframes for high speed data channels, the grant being received before a measurement gap for tuning away from a serving radio access technology (RAT), and at least one high speed subframe allocated in the grant falling within the measurement gap;
processing high speed data, by a user equipment (UE), only on high speed subframes of the plurality of high speed subframes before and after the measurement gap; and
transmitting acknowledgement/negative acknowledgement (ACK/NACK) feedback, by the UE, only considering the high speed subframes of the plurality of high speed subframes before and after the measurement gap.

2. The method of claim 1, in which processing the high speed data comprises receiving high speed downlink data.

3. The method of claim 1, in which processing the high speed data comprises transmitting high speed uplink packet data.

4. The method of claim 3, further comprising receiving ACK/NAK feedback in response to the transmitted high speed uplink packet data.

5. The method of claim 4, in which the transmitted ACK/NAK feedback comprises a bundled ACK/NAK bit or a multiplexed ACK/NAK bit.

6. The method of claim 1, in which the transmitted ACK/NAK feedback comprises a bundled ACK/NAK bit or a multiplexed ACK/NAK bit.

7. A method of wireless communication, comprising:
transmitting a grant allocating a plurality of high speed subframes for high speed data channels, the grant being transmitted before a measurement gap for tuning away from a serving radio access technology (RAT), and at least one high speed subframe allocated in the grant falling within the measurement gap;
processing high speed data, by a NodeB, only on high speed subframes of the plurality of high speed subframes before and after the measurement gap; and
receiving acknowledgement/negative acknowledgement (ACK/NACK) feedback, by the NodeB, only for the high speed subframes of the plurality of high speed subframes before and after the measurement gap.

8. The method of claim 7, in which processing the high speed data comprises receiving high speed uplink packet data.

9. The method of claim 8, further comprising transmitting ACK/NAK feedback in response to the received high speed uplink packet data.

10. The method of claim 9, in which the transmitted ACK/NAK feedback comprises a bundled ACK/NAK bit or a multiplexed ACK/NAK bit.

11. The method of claim 7, in which processing the high speed data comprises transmitting high speed downlink data.

12. The method of claim 7, in which the received ACK/NAK feedback comprises a bundled ACK/NAK bit or a multiplexed ACK/NAK bit.

13. An apparatus for wireless communication, comprising:
a memory unit; and
at least one processor coupled to the memory unit, the at least one processor being configured:
to receive a grant allocating a plurality of high speed subframes for high speed data channels, the grant being received before a measurement gap for tuning away from a serving radio access technology (RAT), and at least one high speed subframe allocated in the grant falling within the measurement gap;
to process high speed data only on high speed subframes of the plurality of high speed subframes before and after the measurement gap; and
to transmit acknowledgement/negative acknowledgement (ACK/NACK) feedback only considering the high speed subframes of the plurality of high speed subframes before and after the measurement gap.

14. The UE of claim 13, in which processing the high speed data comprises receiving high speed downlink data.

15. The UE of claim 13, in which processing the high speed data comprises transmitting high speed uplink packet data.

16. The UE of claim 15, in which the at least one processor is further configured to receive ACK/NAK feedback in response to the transmitted high speed uplink packet data.

17. The UE of claim 16, in which the transmitted ACK/NAK feedback comprises a bundled ACK/NAK bit or a multiplexed ACK/NAK bit.

18. The UE of claim 13, in which the transmitted ACK/NAK feedback comprises a bundled ACK/NAK bit or a multiplexed ACK/NAK bit.

19. An apparatus for wireless communication, comprising:
a memory unit; and
at least one processor coupled to the memory unit, the at least one processor being configured:
to transmit a grant allocating a plurality of high speed subframes for high speed data channels, the grant being transmitted before a measurement gap for tuning away from a serving radio access technology (RAT), and at least one high speed subframe allocated in the grant falling within the measurement gap;
to process high speed data only on high speed subframes of the plurality of high speed subframes before and after the measurement gap; and
to receive acknowledgement/negative acknowledgement (ACK/NACK) feedback only for the high speed subframes of the plurality of high speed subframes before and after the measurement gap.

20. The NodeB of claim 19, in which processing the high speed data comprises receiving high speed uplink packet data.

21. The NodeB of claim 20, in which the at least one processor is further configured to transmit ACK/NAK feedback in response to the received high speed uplink packet data.

22. The NodeB of claim 21, in which the transmitted ACK/NAK feedback comprises a bundled ACK/NAK bit or a multiplexed ACK/NAK bit.

23. The NodeB of claim 19, in which processing the high speed data comprises transmitting high speed downlink data.

24. The NodeB of claim 19, in which the received ACK/NAK feedback comprises a bundled ACK/NAK bit or a multiplexed ACK/NAK bit.
